(19) United States
(12) Patent Application Publication
(10) Pub. No.: US 2018/0334016 A1
(43) Pub. Date: Nov. 22, 2018

(54) Window Covering System

(71) Applicant: Timmy Matthews, Seaside, OR (US)

(72) Inventor: Timmy Matthews, Seaside, OR (US)

(21) Appl. No.: 15/596,822

(22) Filed: May 16, 2017

(51) Int. Cl. B60J 1/20; E06B 9/54

(52) U.S. Cl. CPC B60J 1/2063; B60J 5/04; E06B 9/54

(57) ABSTRACT

A window covering system for covering an open window in a vehicle includes a vehicle that has a door and a window opening extending through the door. A screen unit is provided and the screen unit is coupled to the door. The screen unit is selectively positioned in a deployed position to completely cover the window opening. In this way the screen unit inhibits a person outside of the vehicle from reaching through the window opening. The screen unit is substantially comprised of a fluid permeable material to pass air therethrough. The screen unit is selectively positioned in a stored position having the window opening being exposed.

### CROSS-REFERENCE TO RELATED APPLICATIONS

### Not Applicable

### STATEMENT REGARDING FEDERALLY SPONSORED RESEARCH OR DEVELOPMENT

### Not Applicable

### THE NAMES OF THE PARTIES TO A JOINT RESEARCH AGREEMENT

### Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

### Not Applicable

### STATEMENT REGARDING PRIOR DISCLOSURES BY THE INVENTOR OR JOINT INVENTOR

### Not Applicable

### BACKGROUND OF THE INVENTION

### (1) Field of the Invention.

### (2) Description of Related Art Including Information Disclosed Under 37 CFR 1.97 and 1.98.

The disclosure and prior art relates to covering devices and more particularly pertains to a new covering device for covering an open window in a vehicle.

### BRIEF SUMMARY OF THE INVENTION

An embodiment of the disclosure meets the needs presented above by generally comprising a vehicle that has a door and a window opening extending through the door. A screen unit is provided and the screen unit is coupled to the door. The screen unit is selectively positioned in a deployed position to completely cover the window opening. In this way the screen unit inhibits a person outside of the vehicle from reaching through the window opening. The screen unit is substantially comprised of a fluid permeable material to pass air therethrough. The screen unit is selectively positioned in a stored position having the window opening being exposed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a window covering system according to an embodiment of the disclosure.

FIG. 2 is a back view of an embodiment of the disclosure.

FIG. 3 is a right side view of an embodiment of the disclosure.

FIG. 4 is a front view of an embodiment of the disclosure.

FIG. 5 is a front perspective view of an embodiment of the disclosure.

FIG. 6 is a perspective view of an alternative embodiment of the disclosure.

FIG. 7 is a right side perspective view of an alternative embodiment of the disclosure.

### DETAILED DESCRIPTION OF THE INVENTION

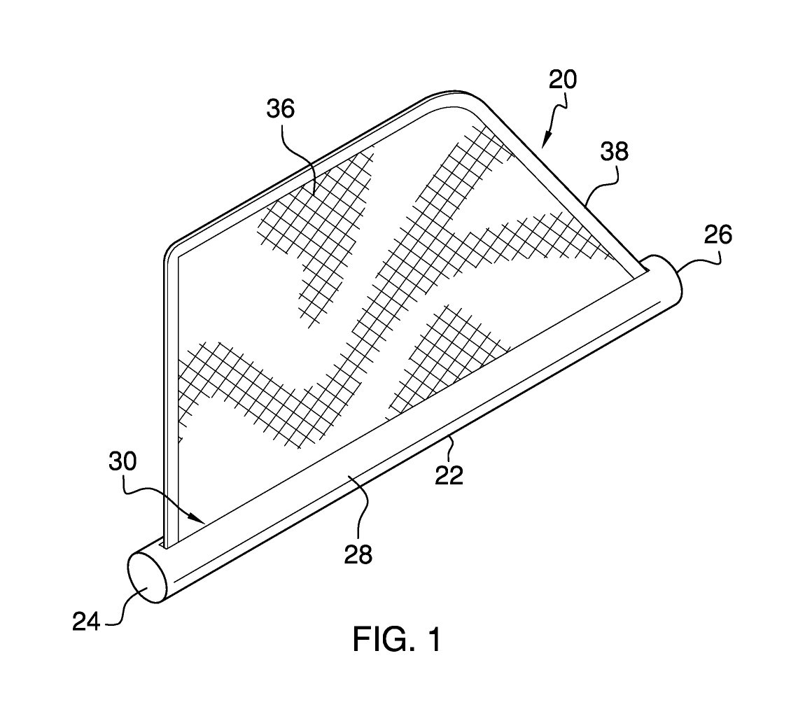

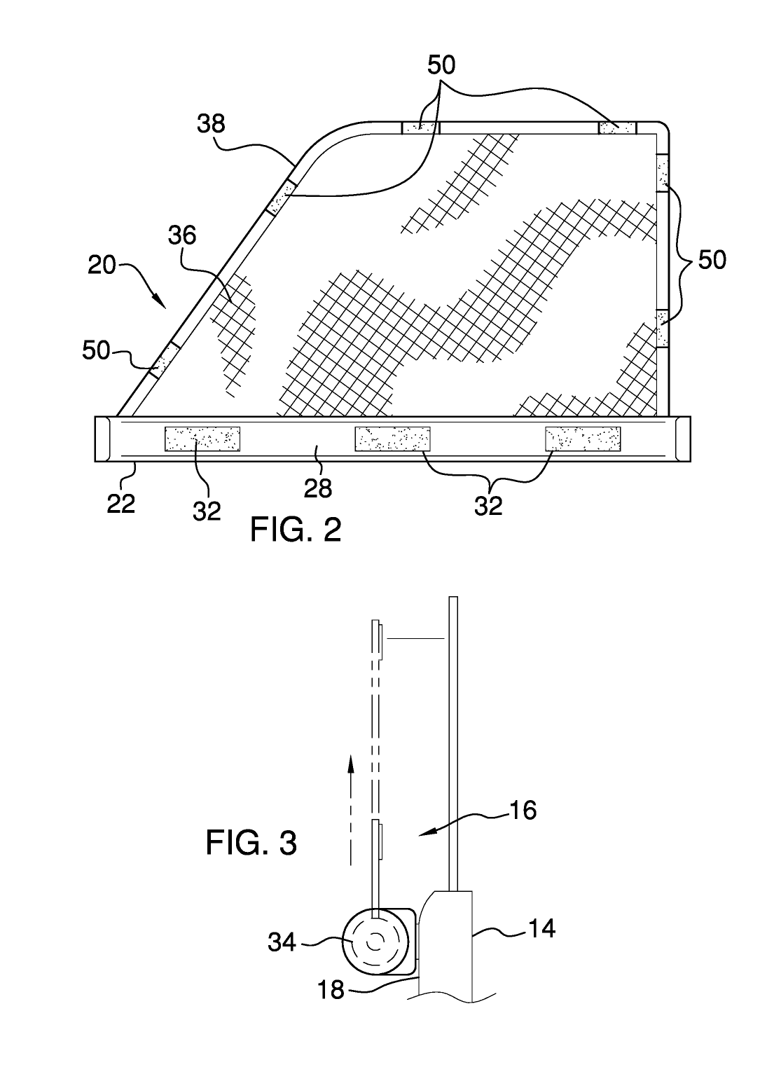

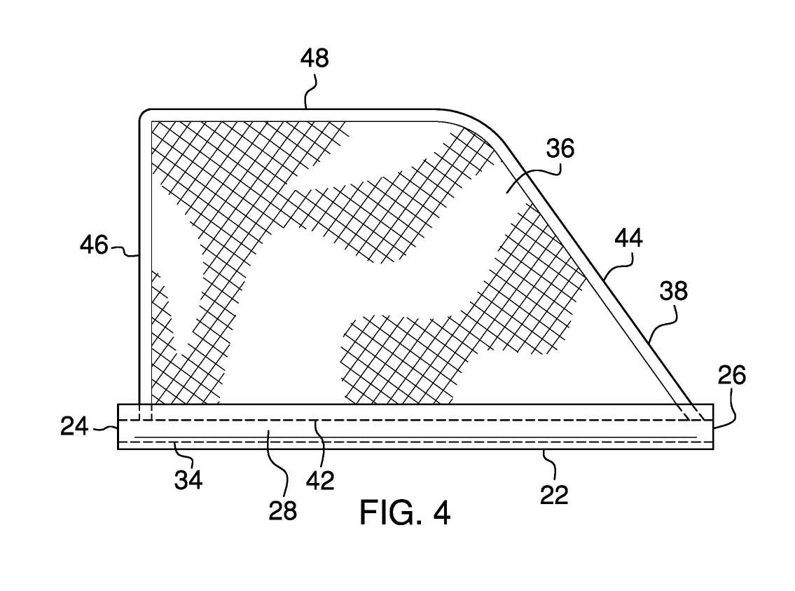

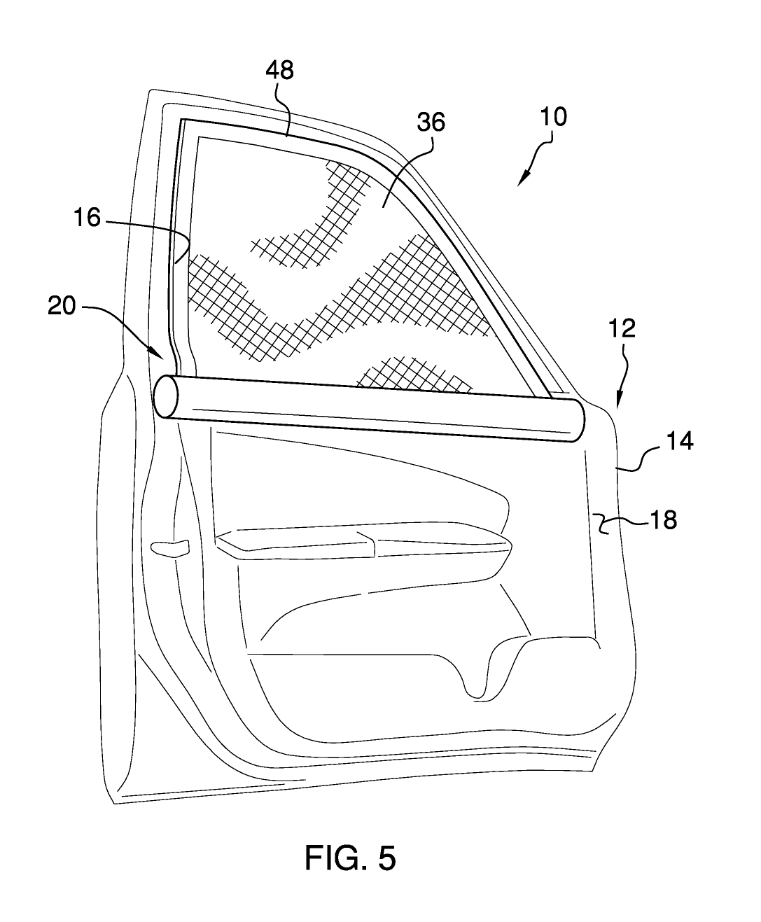

With reference now to the drawings, and in particular to FIGS. 1 through 7 thereof, a new covering device embodying the principles and concepts of an embodiment of the disclosure and generally designated by the reference numeral 10 will be described.

As best illustrated in FIGS. 1 through 7, the window covering system 10 generally comprises a vehicle 12 that has a door 14 and a window opening 16 extending through the door 14, and the door 14 has an inside surface 18. The vehicle 12 may be a passenger vehicle 12 such as a car, a pickup or any other vehicle that has an enclosed cab. A screen unit 20 is provided and the screen unit 20 is coupled to the door 14. The screen unit 20 is selectively positioned in a deployed position such that the screen unit 20 completely covers the window opening 16. In this way the screen unit 20 inhibits a person outside of the vehicle 12 from reaching through the window opening 16.

The screen unit 20 is substantially comprised of a fluid permeable material to pass air therethrough. Thus, air passes through the screen unit 20 when a window in the door 14 is rolled down. The screen unit 20 inhibits access through the window opening 16 when the window is rolled down. The screen unit 20 is selectively positioned in a stored position having the window opening 16 being exposed.

The screen unit 20 comprises a cylinder 22 that has a first end 24, a second end 26 and an outer wall 28 extending therebetween. The cylinder 22 is substantially hollow and the outer wall 28 has a slot 30 extending into an interior of the cylinder 22. The slot 30 extends substantially between the first end 24 and the second end 26. The cylinder 22 has a length that is sufficient to extend along an entire width of the window opening 16.

A plurality of first mating members 32 is provided and each of the first mating members 32 is coupled to the outer wall 28. Each of the first mating members 32 releasably engages the inside surface 18 of the door 14 having the cylinder 22 being positioned beneath the window opening 16. Each of the first mating members 32 may comprise magnets to magnetically engage the door 14. Additionally, each of the first mating members 32 may comprise adhesive pads to adhesively engage the door 14.

A spool 34 is provided and the spool 34 is rotatably positioned within the cylinder 22. The spool 34 extends between the first end 24 and the second end 26. The spool 34 is selectively rotated in a first direction and a second direction. Moreover, the spool 34 is biased to rotate in the first direction and the spool 34 may be a spring loaded spool 34 or the like.

A screen 36 is wrapped around the spool 34 and the screen 36 is selectively drawn off of the spool 34 when the spool 34 is rotated in the second direction. The screen 36 has a peripheral edge 38 and a first surface 40, and the peripheral edge 38 has a bottom side 42, a first lateral side 44, a second lateral side 46 and a top side 48. The bottom side 42 is coupled to the spool 34 and the screen 36 is urged outwardly from the slot 30 when the screen unit 20 is positioned in the deployed position.

The top side 48 of the screen 36 is spaced from the cylinder 22 when the screen unit 20 is positioned in the deployed position. Additionally, the first lateral side 44 may angle inwardly between the bottom side 42 and the top side 48. In this way the screen 36 may conform to a conventional shape the window opening 16 in a front door 14 of the vehicle 12. The screen 36 is comprised of a mesh material to pass air through the window opening 16 when the screen unit 20 is in the deployed position. The screen 36 may have a solid border that defines the peripheral edge 38 of the screen 36.

A plurality of second mating members 50 is provided and each of the second mating members 50 is coupled to the first surface 40 of the screen 36. The second mating members 50 are spaced apart from each other and are distributed around the first lateral side 44, the top side 48 and the second lateral side 46 of the screen 36. Each of the second mating members 50 releasably engages the inside surface 18 of the door 14 such that the screen 36 is retained to cover the window opening 16. Each of the second mating members 50 may comprise magnets to magnetically engage the door 14. Additionally, each of the second mating members 50 may comprise adhesive pads to adhesively engage the door 14.

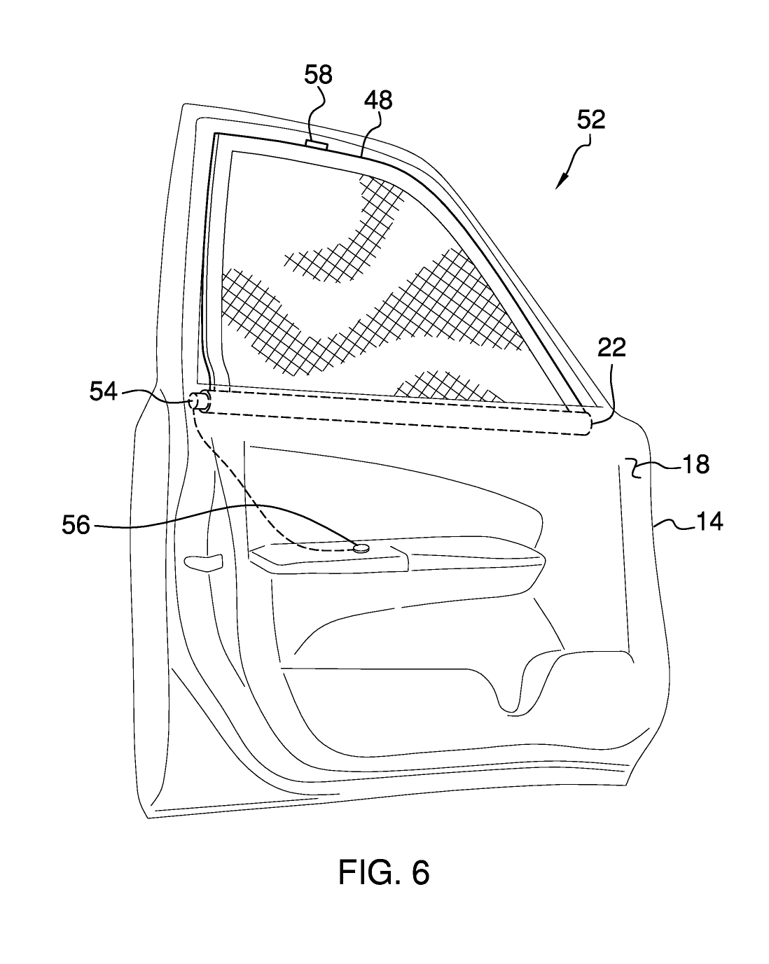

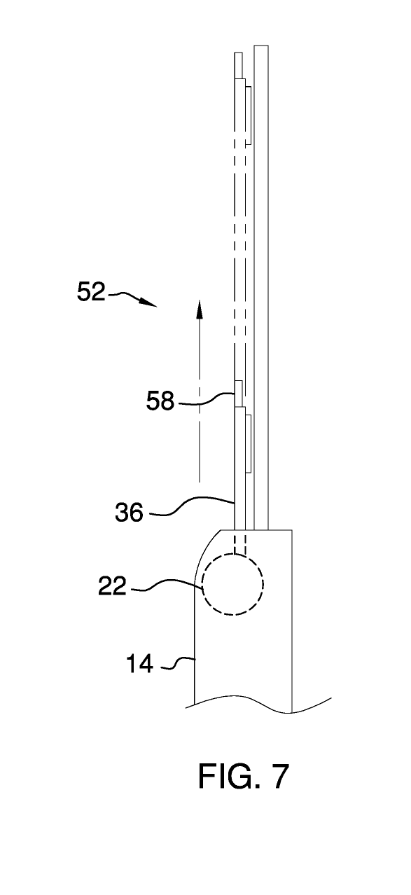

The screen unit 20 may be an aftermarket add-on with respect to the vehicle 12. In an alternative embodiment 52 as shown in FIGS. 6 and 7, the screen unit 20 is shown as a unitary structure with respect to the vehicle 12. As shown in FIGS. 6 and 7, the cylinder 22 may be positioned within the door 14 having the cylinder 22 being aligned with the window opening 16. A motor 54 may be coupled to the cylinder 22 and the motor 54 may be mechanically coupled to the spool 34. Additionally, the motor 54 may be electrically coupled to a button 56 in the vehicle 12 to turn the motor on and off. The motor 54 may urge the spool 34 to selectively rotate in the first and second directions. A tab 58 may be coupled to the top side 48 of the screen 36 for gripping thereby facilitating the screen 36 to be selectively drawn outwardly from the cylinder 22.

In use, the screen 36 is selectively drawn outwardly through the slot 30 and the screen 36 is positioned to cover the window opening 16 in the window. Additionally, the screen 36 is positioned to cover the window opening 16 when the window in the door 14 is rolled down. In this way the screen 36 inhibits an individual from reaching through the window opening 16 when the window is rolled down. Thus, the screen 36 restricts access to a pet or a child that is seated within the vehicle 12 while the vehicle 12 is parked in a public location. In this way the screen unit 20 enhances security with respect to the pet and the child. Additionally, the screen 36 passes air through the window opening 16 to ventilate the vehicle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A window covering system comprising:
a vehicle having a door and a window opening extending through said door; and
a screen unit being coupled to said door, said screen unit selectively positioned in a deployed position such that said screen unit completely covers said window opening wherein said screen unit is configured to inhibit a person outside of said vehicle from reaching through said window opening, said screen unit being substantially comprised of a fluid permeable material wherein said screen unit is configured to pass air therethrough, said screen unit being selectively positioned in a stored position having said window opening being exposed.

2. The assembly according to claim 1, wherein said screen unit comprises a cylinder having a first end, a second end and an outer wall extending therebetween, said cylinder being substantially hollow, said outer wall having a slot extending into an interior of said cylinder, said slot extending substantially between said first end and said second end.

3. The assembly according to claim 2, further comprising a plurality of first mating members, each of said first mating members being coupled to said outer wall, each of said first mating members releasably engaging an inside surface of said door having said cylinder being positioned beneath said window opening.

4. The assembly according to claim 2, further comprising a spool being rotatably positioned within said cylinder, said spool extending between said first end and said second end, said spool being selectively rotated in a first direction and a second direction, said spool being biased to rotate in said first direction.

5. The assembly according to claim 4, further comprising a screen being wrapped around said spool such that said screen is selectively drawn off of said spool when said spool is rotated in said second direction.

6. The assembly according to claim 5, wherein said screen has a peripheral edge and a first surface, said peripheral edge having a bottom side, a first lateral side, a second lateral side and a top side, said bottom side being coupled to said spool, said screen being urged outwardly from said slot when said screen unit is positioned in said deployed position having said top side being spaced from said cylinder.

7. The assembly according to claim 6, further comprising plurality of second mating members, each of said second mating members being coupled to said first surface of said screen, said second mating members being spaced apart from each other and being distributed around said first lateral side, said top side and said second lateral side of said screen, each of said second mating members releasably engaging an inside surface of said door such that said screen is retained to cover said window opening.

8. A window covering system comprising:
a vehicle having a door and a window opening extending through said door, said door having an inside surface; and
a screen unit being coupled to said door, said screen unit selectively positioned in a deployed position such that said screen unit completely covers said window opening wherein said screen unit is configured to inhibit a person outside of said vehicle from reaching through said window opening, said screen unit being substantially comprised of a fluid permeable material wherein said screen unit is configured to pass air therethrough, said screen unit being selectively positioned in a stored position having said window opening being exposed, said screen unit comprising:
a cylinder having a first end, a second end and an outer wall extending therebetween, said cylinder being substantially hollow, said outer wall having a slot extending into an interior of said cylinder, said slot extending substantially between said first end and said second end,
a plurality of first mating members, each of said first mating members being coupled to said outer wall, each of said first mating members releasably engaging said inside surface of said door having said cylinder being positioned beneath said window opening,
a spool being rotatably positioned within said cylinder, said spool extending between said first end and said second end, said spool being selectively rotated in a first direction and a second direction, said spool being biased to rotate in said first direction,
a screen being wrapped around said spool such that said screen is selectively drawn off of said spool when said spool is rotated in said second direction, said screen having a peripheral edge and a first surface, said peripheral edge having a bottom side, a first lateral side, a second lateral side and a top side, said bottom side being coupled to said spool, said screen being urged outwardly from said slot when said screen unit is positioned in said deployed position having said top side being spaced from said cylinder, and
a plurality of second mating members, each of said second mating members being coupled to said first surface of said screen, said second mating members being spaced apart from each other and being distributed around said first lateral side, said top side and said second lateral side of said screen, each of said second mating members releasably engaging said inside surface of said door such that said screen is retained to cover said window opening.
